(19) United States
(12) Patent Application Publication
(10) Pub. No.: US 2009/0068477 A1
(43) Pub. Date: Mar. 12, 2009

(54) Method for Applying an Adhesion Promoter Composition by Means of an Ultrasonic Atomizer

(75) Inventor: Manuel Buck, Gebenstorf (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/224,092

(22) PCT Filed: May 16, 2007
(86) PCT No.: PCT/EP2007/054750

§ 371 Date: Aug. 18, 2008

(30) Foreign Application Priority Data
May 16, 2006 (EP) 06114042.2

(51) Int. Cl. B32B 9/00; B05D 5/10; B32B 38/12

(52) U.S. Cl. 428/448; 427/600; 156/73.1; 428/457

(57) ABSTRACT

The present invention relates to the use of an ultrasonic atomizer for applying an adhesion promoter composition to at least one substrate surface, and to a method for gluing or sealing at least two substrates, wherein an adhesion promoter composition is applied by means of an ultrasonic vaporizer to at least one substrate before the gluing or sealing.

### FIELD OF THE INVENTION

The invention relates to the field of the application technology for applying hydrolyzable liquids, more particularly adhesion promoter compositions, to a surface.

### BACKGROUND ART

Hydrolyzable liquids such as adhesion promoter compositions have long been used for improving adhesion, more particularly that of adhesives and sealants. In particular, silane compounds and titanate compounds have long been known as such adhesion promoter compositions. These adhesion promoter compositions are used as primers or adhesion activators for the pretreatment of surfaces where adhesive bonding or sealing is to take place.

The application of these hydrolyzable liquids to a surface is accomplished for example by a spraying, spreading or rolling process. All of the known processes, however, suffer from the problem that the metering of the applied amount is difficult. Thus, when carrying out application by means of brush, cloth, felt or sponge, it is necessary in some cases in a second step to wipe off part of the applied amount again, with a further cloth, felt or sponge, in order to avoid overmetering, and this is time-consuming and costly. Moreover, the application of adhesion promoter compositions of relatively high viscosity, such as primers, with a cloth, felt or sponge is sensible only to smooth surfaces, since in the case of rough surfaces the primer, with this method of application, fails to penetrate all of the pores and is unable to wet the entire surface. A consequence of this is that the adhesive or sealant applied to a substrate surface pretreated with a primer does not adhere equally well at every point.

In the case of the spraying process the problem exists of what is called overspray, in other words the fact that, in the course of spraying, it is not possible to precisely delimit the area to be coated, and the hydrolyzable liquid is applied even at locations which are not brought into contact with adhesives or sealants. This leads to an unnecessary consumption of material and may also give rise to unattractiveness or necessitate an additional cleaning step.

With all of the conventional application processes the problem exists that it is difficult to apply the adhesion promoter compositions in small amounts. In order to allow the application of small amounts to a surface, the adhesion promoter compositions are in some cases diluted, preferably with a volatile solvent. Accordingly there is a need that exists to provide a process which allows hydrolyzable liquids to be applied in thin films and small amounts, and also in uniform distribution and on a confined, pre-defined area. Since adhesion promoter compositions are frequently used in closed production facilities, where the evaporation of the solvents poses a health risk to the workers, there is a need, moreover, to provide a process which also allows the application of solvent-free adhesion promoter substances.

### BRIEF DESCRIPTION OF THE INVENTION

It is an object of the present invention, therefore, to provide a process which overcomes the disadvantages of the prior art and more particularly makes it possible for hydrolyzable liquids to be applied to a pre-defined area of a surface and makes it possible more particularly to allow uniform distribution even on uneven surfaces.

Surprisingly it has been found that in accordance with claim 1 an ultrasonic atomizer represents one such means which achieves this object.

This method is suitable more particularly for adhesion promoter compositions which are used to improve the adhesion for adhesives and sealants. One of the advantages of the present invention, then, is that adhesion promoter substances can be applied without solvents, in thin films, to a surface.

Through the use of an ultrasonic atomizer it is also possible to apply a two-component hydrolyzable liquid. Moreover, the use of the ultrasonic atomizer permits a rapid and reliable method of applying an adhesion promoter composition, leading to a quicker and reliable operation when adhesively bonding and sealing, and also to lower materials costs or work costs.

Further subjects of the present invention, accordingly, are a method of adhesive bonding and sealing, an adhesively bonded or sealed article, and a built structure or means of transport.

Preferred embodiments of the invention are the subject of the dependent claims.

### CERTAIN EMBODIMENTS OF THE INVENTION

The present invention relates to the use of an ultrasonic atomizer to apply a hydrolyzable liquid to at least one substrate surface.

As ultrasonic atomizer it is possible to use conventional ultrasonic atomizers which comprise an ultrasound transducer in which piezoceramic elements generate mechanical vibrations from electrical oscillations. In the case of the present invention the piezoceramic element is wetted with reactive liquid and set in vibration by ultrasound. The liquid is excited into capillary waves, from the crest of which fine droplets are cut off and spun out. The operating frequency of the piezoceramic element is preferably 1 to 1000 kHz, more particularly 10 to 500 kHz, more preferably 20 to 200 kHz, more preferably still 50 to 100 kHz.

The ultrasonic atomizer is preferably part of an atomizer device for generating a directed spray mist, the atomizer device comprising a housing part with a container to hold the liquid to be nebulized, and also comprising an applicator nozzle, which governs the direction of the droplets, so that, through uniform distribution of the supplied quantity of liquid on the substrate surface, the hydrolyzable liquid forms a confined film of liquid having the desired film thickness. With particular preference the ultrasonic atomizer is a part of the applicator nozzle.

Particularly suitable ultrasonic atomizers are those which generate an atomized liquid which for the most part, i.e., a maximum in the frequency distribution, contains droplets having a diameter of less than 200 μm, preferably between 1 and 100 μm, more preferably still between 10 and 70 μm, most preferably between 20 and 60 μm.

Preference is given to using an ultrasonic atomizer which can be set so that it can generate on the substrate surface a film of the hydrolyzable liquid that has a dry film thickness of preferably approximately between 10 nm and 15 μm, preferably between 50 nm and 1 μm, more preferably still between 70 and 150 nm. It is possible for two or more films to be applied in succession. In this way, preferably, the hydrolyzable liquid is applied in an amount between 5 and 200 g/m², more particularly between 10 and 100 g/m², and, in the case of an adhesion promoter composition comprising organosilicon, organotitanium and/or organozirconium compound, in an amount of 0.02 to 40 g/m², more particularly 0.1 to 20 g/m², preferably 0.5 to 10 g/m², of organosilicon, organotitanium and/or oganozirconium compound.

An ultrasound atomizer which has proven particularly suitable is one from the company Lechler GmbH, Germany, more particularly the ultrasonic atomizer of type US2 or US1.

An ultrasonic atomizer with an atomizer device where the hydrolyzable liquid, more particularly the adhesion promoter composition, is applied to the substrate surface with the aid of at least one carrier gas has proven particularly advantageous. Suitable carrier gases are common air, oxygen, carbon dioxide or an inert gas such as nitrogen or argon, for example. The carrier gas, more particularly air, may contain a certain amount of moisture, more particularly water. If air is used as the carrier gas, the air humidity at 20° C. is preferably between 20% and 70%. The amount of water is preferably calculated such that the hydrolyzable liquid is able to undergo hydrolysis or partial hydrolysis until it impinges on the surface to be treated. Under pressure, the carrier gas is able to transport the droplets of liquid generated by the ultrasonic atomizer onto the substrate surface. The atomizer pressure here may be chosen such that the droplets are able to bridge relatively large distances and are largely unaffected by a disturbed ambient atmosphere. However, the pressure should be chosen only at such a level that the droplets of liquid in general do not rebound too greatly from the substrate surface and do not too heavily contaminate the edge of the application area. The pressure is preferably between 0 and 5 bar, more preferably still between 1 and 2 bar, preferably about 1 bar. This means that the droplets of liquid can be applied to a substrate surface both with and without additional carrier gas. In the first version the droplets of liquid are dropped onto the substrate surface by gravity; in the second version the droplets of liquid are applied to the surface in a targeted way, if appropriate even in a protective atmosphere.

In one embodiment of the present invention the carrier gas may comprise at least one additional component K2 which is applied to the substrate surface with the droplets, generated by the ultrasonic atomizer, of the first component K1 which comprises at least one hydrolyzable liquid. It may be of advantage if the second component K2 is likewise passed through a second ultrasonic atomizer which atomizes the second component K2 into droplets. The carrier gas then passes the droplets of the second component K2 past the ultrasonic atomizer for the first component K1 of the hydrolyzable liquid and on to the substrate surface, the droplets of component K2 mixing with the droplets of component K1, and possibly reacting with one another, or the droplets of component K2 initiating or catalyzing condensation of component K1. The choice of the sequence—whether first the first component K1 or the second component K2 is taken up by the carrier gas and then passed via the other component in each case—is arbitrary.

The advantage of the present invention when applying at least two components, with at least one component comprising a hydrolyzable liquid, is that the components are mixed with one another in small droplets, leading to effective mixing and hence to a rapid reaction.

In one preferred version the first component K1 contains at least one functional group Y and the second component K2 contains at least one functional group Z, the functional group Y and the functional group Z reacting with one other chemically, more particularly via an addition reaction.

The functional group Y is selected more particularly from the group encompassing oxirane, (meth)acryloyloxy, NCO, alkoxysilane, and vinyl group, more particularly NCO, epoxy, (meth)acrylic acid, (meth)acrylate, and alkoxysilane, and the group Z is selected more particularly from the group encompassing COOH, NH₂, NH, SH, and OH.

Component K2, which reacts with component K1 or which initiates or catalyzes condensation of component K1, is preferably an organotin compound or an acid.

In one preferred embodiment component K2 is an organotin compound and constitutes preferably a dialkyltin diacetylacetonate or a dialkyltin dicarboxylate, and more particularly is dibutyltin dilaurate or dibutyltin diacetate. Component K2 is preferably dibutyltin dilaurate.

In another preferred embodiment component K2 is an acid. The acid may be an organic acid or an inorganic acid. The acid typically has a pKa1 of less than 6.

Suitability as inorganic acid is possessed more particularly by phosphorus acids or sulfur acids. Sulfonic acid or phosphoric acid, more particularly sulfuric acid, have proven particularly suitable.

Suitability as organic acids is possessed more particularly by formic, acetic, amino acid. Acetic acid has proven particularly suitable.

In a further version the first component K1 comprises at least one compound which polymerizes under the influence of a catalyst or initiator which is present in the second component K2.

In one preferred embodiment of this version the compound of component K1 that polymerizes under the influence of a catalyst or initiator of component K2 is an unsaturated compound which is selected from the group consisting of styrene, acrylonitrile, (meth)acrylamides, (meth)acrylic acid, (meth)acrylates, vinyl alcohols, vinyl ethers, and unsaturated polyesters and is preferably a (meth)acrylate. The second component K2 of this embodiment comprises as initiator a free-radical initiator, more particularly a peroxide or hydroperoxide or a perester, preferably an organic peroxide.

Components K1 to K2 may also comprise further constituents of the kind known to the skilled worker for two-component compositions. Further constituents of this kind are, more particularly, additives such as plasticizers, fillers, adhesion promoters, UV absorbers, UV stabilizers and/or heat stabilizers, antioxidants, flame retardants, optical brighteners, catalysts, color pigments or dyes. Particularly preferred such further constituents are fillers. Preferred fillers are carbon black and chalks, both coated and uncoated.

Throughout the present text a “hydrolyzable liquid” which can be applied with an ultrasonic atomizer in accordance with the present invention is a liquid which reacts with water and is thereby cleaved. Particularly suitable in accordance with the present invention are liquids which are of low viscosity and have a dynamic viscosity of up to about 10 to 100 mPa*s, preferably up to about 20 to 60 mPa*s. Particular preference is given to solids-free liquids. However, liquids which contain fine particulate solids such as carbon black are also suitable. Hydrolyzable liquids suitable more particularly are adhesion promoter compositions, more particularly adhesion promoter compositions comprising at least one hydrolyzable adhesion promoter substance comprising or consisting of a silane, titanate and/or zirconium compound.

The at least one hydrolyzable adhesion promoter substance may be an organosilicon compound. Suitable in principle are all organosilicon compounds known to the skilled worker that are used as adhesion promoters. This organosilicon compound preferably carries at least one, more particularly at least two, alkoxy groups, which is or are attached directly to a silicon atom via an oxygen-silicon bond. The organosilicon compound additionally carries at least one substituent which is attached to the silicon atom via a silicon-carbon bond, and which optionally contains a functional group which is selected from the group encompassing oxirane, hydroxyl, (meth)acryloyloxy, amino, mercapto, and vinyl group.

Particularly suitable organosilicon compounds are organosilicon compounds of the formulae (I) or (II) or (III)

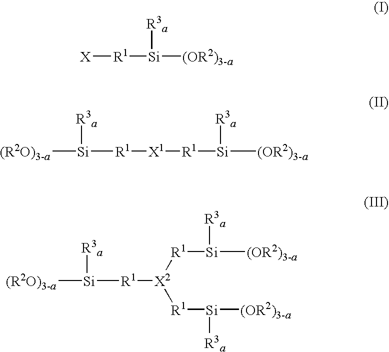

R¹ here stands for a linear or branched, optionally cyclic, alkylene group having 1 to 20 C atoms, optionally with aromatic fractions, and optionally with one or more heteroatoms, more particularly nitrogen atoms.

R² here stands for an alkyl group having 1 to 5 C atoms, more particularly for methyl or ethyl, or an acyl group.

R³ here stands for an alkyl group having 1 to 8 C atoms, more particularly methyl.

X here stands for an H, or a functional group which is selected from the group encompassing oxirane, OH, (meth)acryloyloxy, amine, SH, acylthio, and vinyl, preferably amine. For the sake of completeness it is mentioned that acylthio in this document means the substituent

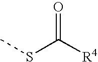

where R⁴ stands for alkyl, more particularly having 1 to 20 carbon atoms, and the dashed line represents the bond to the substituent R¹.

X¹ here stands for a functional group which is selected from the group encompassing NH, S, S₂, and S₄.

X² here stands for a functional group which is selected from the group encompassing N and isocyanurate.

a here stands for one of the values 0, 1 or 2, preferably 0.

The substituent R¹ denotes more particularly a methylene, propylene, methylpropylene, butylene or dimethylbutylene group. As particularly preferred is. As substituent R¹ a propylene group.

Organosilicon compounds containing amino, mercapto or oxirane groups are also referred to as “aminosilanes”, “mercaptosilanes”, or “epoxysilanes”.

Examples of suitable organosilicon compounds of the formula (I) are the organosilicon compounds selected from the group encompassing ocxtyltrimethoxysilane, dodecyltrimethoxysilane, hexadecyltrimethoxysilane, methyloctyldimethoxysilane; 3-glycidyloxypropyltrimethoxysilane, 3-glycidyloxypropyltriethoxysilane; 3-methacryloyloxypropyltrialkoxysilanes, 3-methacryloyloxypropyltriethoxysilane, 3-methacryloyloxypropyltrimethoxysilane; 3-aminopropyltrimethoxysilane, 3-aminopropyltriethoxysilane, 3-aminopropyldimethoxymethylsilane, 3-amino-2-methylpropyltrimethoxysilane, N-(2-aminoethyl)-3-aminopropyltrimethoxysilane, N-(2-aminoethyl)-3-aminopropyltriethoxysilane, N-(2-aminoethyl)-3-aminopropyldimethoxymethylsilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane, 7-amino-4-oxaheptyldimethoxymethylsilane, N-(methyl)-3-aminopropyltrimethoxysilane, N-(n-butyl)-3-aminopropyltrimethoxysilane; 3-mercaptopropyltriethoxysilane, 3-mercaptopropyltrimethoxysilane, 3-mercaptopropylmethyldimethoxysilane; 3-acylthiopropyltrimethoxysilane; vinyltrimethoxysilane and vinyltriethoxysilane.

Also preferred are the organosilicon compounds as just mentioned whose alkoxy groups have been replaced by acetoxy groups, such as octyltriacetoxysilane (octyl-Si(O(O═C)CH₃)₃), for example. Organosilicon compounds of this kind give off acetic acid on hydrolysis.

Preferred among these stated organosilicon compounds are those which have an organic substituent attached to the silicon atom that additionally contains a functional group as well, i.e., that is not an alkyl group, and conform to a formula (I) in which X is not H.

Examples of suitable organosilicon compounds of the formula (II) are the organosilicon compounds selected from the group encompassing bis[3-(trimethoxysilyl)propyl]amine, bis[3-(triethoxysilyl)propyl]amine, 4,4,15,15-tetraethoxy-3,16-dioxa-8,9,10,11-tetrathia-4-15-disilaoctadecane (bis(triethoxysilylpropyl) polysulfide or bis(triethoxysilylpropyl)tetrasulfane), bis(triethoxysilylpropyl) disulfide.

Examples of suitable organosilicon compounds of the formula (III) are the organosilicon compounds selected from the group encompassing tris[3-(trimethoxysilyl)propyl]amine, tris[3-(triethoxysilyl)propyl]amine, 1,3,5-tris[3-(trimethoxysilyl)-propyl]-1,3,5-triazine-2,4,6(1H,3H,5H)trione-urea (i.e., tris(3-(trimethoxysilyl)propyl) isocyanurate), and 1,3,5-tris[3-(triethoxysilyl)propyl]-1,3,5-triazine-2,4,6(1H,3H,5H)trione-urea (i.e., tris(3-(triethoxysilyl)propyl) isocyanurate).

Preferred organosilicon compounds are aminosilanes, more particularly aminosilanes with X═NH₂ or NH₂—CH₂—CH₂—NH, X¹═NH, and X²═N. Particular preference is given to 3-aminopropyltrimethoxysilane, N-(2-aminoethyl)-3-aminopropyltrimethoxysilane, bis[3-(trimethoxysilyl)propyl]amine, 3-aminopropyltriethoxysilane, N-(2-aminoethyl)-3-aminopropyltriethoxysilane, and bis[3-(triethoxysilyl)propyl]amine, and also to their mixtures with one another. It has emerged that, more particularly with aminosilanes, especially in the case of the aminosilanes mentioned in this section, the microcracking of the thermally cured silicone coating is reduced.

The at least one hydrolyzable adhesion promoter substance may additionally be an organotitanium compound. Suitable in principle are all organotitanium compounds known to the skilled worker that are used as adhesion promoters.

Of more particular suitability are organotitanium compounds which carry at least one functional group which is selected from the group encompassing alkoxy group, sulfonate group, carboxylate group, dialkyl phosphate group, dialkyl pyrophosphate group, and acetylacetonate group, or mixtures thereof, and which is attached directly to a titanium atom via an oxygen-titanium bond.

Particularly suitable compounds are those in which all of the substituents attached to the titanium are selected from the group encompassing alkoxy group, sulfonate group, carboxylate group, dialkyl phosphate group, dialkyl pyrophosphate group, and acetylacetonate group, it being possible for all of the substituents to be identical or different from one another.

Having proven particularly suitable as alkoxy groups are, more particularly, those substituents known as neoalkoxy substituents, more particularly of the formula (IV) below

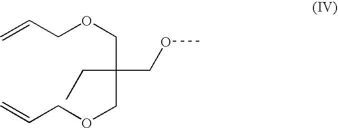

Having proven particularly suitable as sulfonic acids are, more particularly, aromatic sulfonic acids whose aromatics are substituted by an alkyl group. Considered preferred sulfonic acids are radicals of the formula (V) below

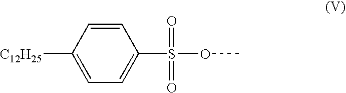

Having proven particularly suitable as carboxylate groups are, more particularly, carboxylates of fatty acids. Decanoate is considered to represent preferred carboxylates.

In the formulae (IV) and (V) above, the dashed bond indicates the oxygen-titanium bond.

Organotitanium compounds are available commercially, from the company Kenrich Petrochemicals or DuPont, for example. Examples of suitable organotitanium compounds compounds are, for example, Ken-React® KR TTS, KR 7, KR 9S, KR 12, KR 26S, KR 33DS, KR 38S, KR 39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 55, LICA 01, LICA 09, LICA 12, LICA 38, LICA 44, LICA 97, LICA 99, KR OPPR, KR OPP2 from Kenrich Petrochemicals or Tyzor® ET, TPT, NPT, BTM, AA, AA-75, AA-95, AA-105, TE, ETAM, OGT from DuPont. Considered preferred are Ken-React® KR 7, KR 9S, KR 12, KR 26S, KR 38S, KR44, LICA 09, LICA 44, NZ 44, and also Tyzor® ET, TPT, NPT, BTM, AA, AA-75, AA-95, AA-105, TE, ETAM from DuPont.

Particularly preferred are organotitanium compounds having substituents of the formulae (IV) and/or (V) attached to the titanium atom via an oxygen-titanium bond.

The at least one hydrolyzable adhesion promoter substance may additionally be an organozirconium compound. Suitability is possessed in principle by all of the organozirconium compounds known to the skilled worker that are used as adhesion promoters. Suitable more particularly are organozirconium compounds which carry at least one functional group which is selected from the group encompassing alkoxy group, sulfonate group, carboxylate group, phosphate group or mixtures thereof, and which is attached directly to a zirconium atom via an oxygen-zirconium bond.

Alkoxy groups having proven particularly suitable are, more particularly, isopropoxy substituents and those substituents known as neoalkoxy substituents, more particularly of the formula (IV) as described above, the dashed bond here indicating the oxygen-zirconium bond.

Having proven particularly suitable as sulfonic acids are, more particularly, aromatic sulfonic acids whose aromatics are substituted by an alkyl group. Considered preferred sulfonic acids are radicals of the following formula (V) as described above, the dashed bond here indicating the oxygen-zirconium bond.

Carboxylate groups which have proven particularly suitable are, more particularly, carboxylates of fatty acids. Stearates and isostearates are considered preferred carboxylates.

Organozirconium compounds are available commercially, from the company Kenrich Petrochemicals, for example. Examples of suitable organozirconium compounds are, for example, Ken-React® NZ 38J, NZ TPPJ, KZ OPPR, KZ TPP, NZ 01, NZ 09, NZ 12, NZ38, NZ 44, NZ 97.

The adhesion promoter substance of the composition of the invention may further comprise mixtures of at least one organosilicon compound with at least one organotitanium compound and/or with at least one organozirconium compound. Also possible are mixtures of at least one organotitanium compound with at least one organozirconium compound. Preferred mixtures are those of at least one organosilicon compound with at least one organotitanium compound.

Particularly preferred mixtures are those of two or more organosilicon compounds or mixtures of one organosilicon compound with one organotitanium compound, or organozirconium compound, respectively.

Of proven suitability as mixtures of organosilicon compounds are, in particular, mixtures of adhesion promoter substances of the formulae (I), at least one of these substituents carrying H as substituent X, and at least one of these substances carrying a functional group which is selected from the group encompassing oxirane, (meth)acryloyloxy, amine, SH, and vinyl, as substituent X. These mixtures are preferably mixtures of at least one alkyltrialkoxysilane with an aminoalkyltrialkoxysilane and/or mercaptoalkyltrialkoxysilane.

The adhesion promoter composition may comprise further constituents besides the hydrolyzable adhesion promoter substances described. A suitable further constituent, for example, is at least one solvent. Suitable solvents in one embodiment are, more particularly, volatile solvents, in other words those having a boiling point at 760 torr of between 25° C. and 140° C., more particularly of between 50° C. and 120° C., preferably of between 65 and 99° C.

In another embodiment less volatile solvents are of more particular suitability, in other words those solvents which have a boiling point at 760 torr above the baking temperature. More particularly they have a boiling point of ≧100° C., preferably between 100° C. and 200° C., more preferably between 140° C. and 200° C.

Additionally it has emerged that, more particularly, mixtures of different solvents are advantageous. It has emerged as being particularly suitable if mixtures of hydrocarbons with one another or mixtures of at least one hydrocarbon with at least one polar solvent that contains at least one heteroatom in its structural formula are used. The hydrocarbon may be saturated or olefinically or aromatically unsaturated. Preferably the hydrocarbon is saturated. Considered suitable as the heteroatom in the polar solvent are, more particularly, O, N, and S. Preferably the at least one heteroatom is an oxygen atom, which with particular preference is present in the form of hydroxyl, carbonyl, ether, carboxylic acid or carboxylic acid derivative groups, such as ester, amide or carboxylate group, for example, in the structural formula of the polar solvent. Preferred polar solvents are water, alcohols, and ketones. Most-preferred polar solvents are alcohols, more particularly saturated, branched or linear or cyclic alcohols having 1 to 8 carbon atoms.

Preferred solvents are alcohols and aliphatic and cycloaliphatic hydrocarbons, more particularly ethanol, isopropanol, hexane, cyclohexane, heptane or octane, and also mixtures thereof. Preferably the solvent is ethanol or heptane.

Considered particularly preferred are solvent mixtures of an alcohol and of an aliphatic or cycloaliphatic hydrocarbon. More particularly those of ethanol or isopropanol with hexane or cyclohexane or heptane or octane, and also mixtures thereof. A solvent mixture which has emerged as being particularly preferred is the mixture of ethanol and heptane.

Considered less-volatile solvents are, more particularly, hydrocarbons such as toluene, xylene or a hydrocarbon mixture having a boiling point between 120° C. and 200° C., more particularly between 120° C. and 140° C.

Using a solvent of this kind it is possible to ensure that homogeneously small concentrations of adhesion promoter substances, i.e., of organosilicon compound and/or organotitanium compound, can be applied to a surface. The solvent content is preferably chosen such that the organosilicon compound and/or organotitanium compound content is from 0.1% to 10% by weight, more particularly between 0.5% to 10% by weight.

It may well also be advantageous, however, for the adhesion promoter composition to contain no solvents and for the organosilicon compound, organozirconium compound and/or organotitanium compound content to be more than 90% by weight, more particularly more than 99% by weight. In this way for example it is possible to avoid disadvantages or limitations imposed by VOC regulations.

It is a particular feature of the present invention that hydrolyzable liquids as well, more particularly adhesion promoter compositions, can be applied uniformly to a substrate surface in thin films without solvents through the use of an ultrasonic atomizer. To date it has been almost impossible to apply solvent-free adhesion promoter compositions by conventional application methods, as for example with a cloth or sponge. For uniform, adequate wetting it was necessary in each case to use a solvent.

A further component that may be present in the adhesion promoter composition is a reactive binder, in which case, more particularly, mention shall be made of polyurethane prepolymers with isocyanate groups and/or silane groups; or there may be polyisocyanates present, for example, tris(4-isocyanatophenyl)methane, tris(4-isocyanatophenyl) thiophosphate, the aforementioned monomeric MDI, TDI, HDI, and IPDI, and also oligomers, polymers or copolymers of these monomers, such as polymeric HDI, polymeric MDI, available commercially for example as Voranate® M 229 (Dow), Desmodur® VL R 20 (Bayer), or allophanates, biurets, uretdiones, and isocyanurates of these monomers, more particularly HDI biurets, as, for example, available commercially as Desmodur® N-100 (Bayer), Luxate® HDB 9000 (Lyondell/Bayer), HDI trimers, as, for example, available commercially as Desmodur® N-3300 (Bayer), Desmodur® N-3600 (Bayer), Luxate® HT 2000 (Lyondell/Bayer), Desmodur® XP 2410, HDI dimers, as, for example, available commercially as Desmodur® N-3400 (Bayer), Luxate® HD 100 (Lyondell/Bayer), IPDI trimers, as, for example, available commercially as Desmodur® Z 4470 (Bayer), Vestanat® T 1890 (Degussa), Luxate® IT 1070 (Lyondell/Bayer), HDI and IPDI allophanates, TDI trimers, as, for example, available commercially as Desmodur® IL (Bayer), TDI adducts, as, for example, available commercially as Desmodur® L (Bayer), TDI/HDI polymers, as, for example, available commercially as Desmodur® HL (Bayer), Polurene® IK D (Sapici), Hartben AM 29 (Benasedo).

Likewise useful as a constituent of the adhesion promoter composition are catalysts for the hydrolysis, for example, of silane groups, and specifically, for example, in the form of organic carboxylic acids such as benzoic acid or salicylic acid, organic carboxylic anhydrides such as phthalic anhydride or hexahydrophthalic anhydride, silyl esters of organic carboxylic acids, organic sulfonic acids such as p-toluenesulfonic acid or 4-dodecylbenzenesulfonic acid, or other organic or inorganic acids, or mixtures of the aforementioned acids; and also catalysts for the reaction of isocyanate groups, examples being tin compounds such as tin(II) octoate, monobutyltin trichloride, dibutyltin dichloride, dibutyltin oxide, dibutyltin diacetate, dibutyltin dilaurate, dibutyltin diacetylacetonate, dibutyltin dicarboxylates, dioctyltin dicarboxylates, alkyltin thioesters, bismuth compounds such as bismuth(III) octoate, bismuth(III) neodecanoate, zinc compounds such as zinc(II) octoate, and also compounds containing amino groups, such as, for example, 2,2′-dimorpholinodiethyl ether, 1,4-diazabicyclo[2.2.2]octane, 1,8-diazabicyclo[5.4.0]-undec-7-ene; and also other catalysts such as titanates and zirconates. Such catalysts may, as already described, also be mixed as second component K2 in drop form with the adhesion promoter composition. In other words, the catalysts can either be present directly in the hydrolyzable liquid, more particularly the adhesion promoter composition, or first mixed with the droplets of the hydrolyzable liquid shortly before the hydrolyzable liquid, more particularly the adhesion promoter composition, is applied.

In addition it is possible to use additives, fillers, and wetting agents that are typical in primer chemistry. Examples, of non-limiting nature, thereof are talc, carbon black, organic and inorganic pigments, stabilizers, and also chemical and physical driers.

Likewise suitable as further constituents are UV absorbers and also optical brighteners. Such optical brighteners absorb UV light and emit visible light, normally blue light. One preferred optical brightener is Ciba Uvitex® OB from Ciba Speciality Chemicals. Further suitable brighteners are specified in Kirk-Othmer, “Encyclopedia of Chemical Technology”, 4th Ed., John Wiley & Sons, New York, vol. 11, pp. 227-241, for example. The UV absorbers may for example be organic in nature, such as those from the Tinuvin® product line from Ciba Speciality Chemicals, for example, or they may be inorganic in nature, such as color pigments, for example, more particularly carbon black or titanium dioxide.

The substrate on whose surface the hydrolyzable liquid is applied by means of an ultrasonic atomizer may vary greatly. Particularly suitability is possessed by inorganic substrates such as glass, glass ceramic, concrete, mortar, brick, tile, plaster, and natural stones such as granite or marble; metals or alloys such as aluminum, steel, nonferrous metals, galvanized metals; organic substrates such as wood, chipboard, plastics such as PVC, polycarbonates, PMMA, polyesters, epoxy resins; coated substrates such as powder-coated metals or alloys; and also paints and finishes, more particularly automobile topcoat finishes. The most-preferred substrates are glass, more particularly ceramic-coated glass, painted substrates, such as painted metal flanges, and also plastics, more particularly PVC.

The present invention further provides a method of applying a hydrolyzable liquid, more particularly an adhesion promoter composition, to at least one substrate surface, in which an ultrasonic atomizer as described above is used for said applying. Preference is given to the use of an ultrasonic atomizer which is part of an applicator nozzle of an atomizer device, which allows precise application to a substrate surface and prevents contamination of the further environment. The atomizing device is preferably designed in such a way that a housing is used to protect against mechanical contact and also to shield disruptive radiation emerging from the ultrasonic atomizer. The housing may also be constructed so as to direct the jet of emerging liquid droplets in such a way that the droplets of liquid are applied to the desired confined area of the substrate surface.

The present invention may be used more particularly in connection with the pretreatment of substrate surfaces which are to be subsequently joined with an adhesive or sealant. Pretreatment in this case is preferably the application of an adhesion promoter substance by means of use of the above-described ultrasonic atomizer. Suitable applications are therefore, for example, the adhesive bonding of components in construction or civil engineering and in the manufacture or repair of industrial goods or consumer goods, more particularly windows, household machines or means of transport such as water or land vehicles, preferably automobiles, buses, trucks, trains or ships; the sealing of joints, seams or cavities in industrial manufacture or repair, or in construction or civil engineering. The present invention is particularly suitable in connection with the application of an adhesion promoter substance to a sheet, preferably of glass, where the sheet is to be joined with at least one further substrate of glass, wood, coating material, or plastic, more particularly polyvinyl chloride (PVC), more particularly by adhesive bonding. Accordingly the method of the invention can be employed preferably in vehicle construction, where glass is bonded with a paint-coated body, or in door or window construction, where glass is bonded with a frame made of wood or plastic.

The invention further provides a method of adhesive bonding and/or sealing of at least two substrate surfaces S1 and S2, comprising the steps of: (i) applying an adhesion promoter composition, using an above-described ultrasonic atomizer, to a substrate S1 and/or a substrate S2; (ii) applying an adhesive or sealant to at least one substrate surface S1 and/or S2 or between the substrates S1 and S2; (iii) contacting the substrates S1 and S2 via the applied adhesive applied or sealant; and (iv) curing the applied adhesive or sealant; the substrates S1 and S2 being alike or different from one another.

In its use as a sealant, the composition is applied between the substrates S1 and S2, and then curing takes place. Typically the sealant is injected into a joint.

The application of the adhesive or sealant takes place preferably uniformly.

In both applications the substrate S1 may be a like or different from substrate S2.

Examples of suitable substrates S1 or S2 are inorganic substrates such as glass, glass ceramic, concrete, mortar, brick, tile, plaster, and natural stones such as granite or marble; metals or alloys such as aluminum, steel, nonferrous metals, galvanized metals; organic substrates such as wood, plastic such as PVC, polycarbonates, PMMA, polyesters, epoxy resins; coated substrates such as powder-coated metals or alloys; and also paints and finishes, more particularly automobile topcoat finishes.

It has emerged that polyurethane adhesives, (meth)acrylate adhesives, epoxy resin adhesives or adhesives based on alkoxysilane-functional prepolymers are extremely suitable for adhesive bonding.

Suitable polyurethane adhesives are, on the one hand, one-component moisture-curing adhesives or two-component polyurethane adhesives. Adhesives of this kind comprise polyisocyanates, more particularly in the form of prepolymers containing isocyanate groups. Preference is given to polyurethane adhesives of the kind sold commercially by Sika Schweiz AG under the product lines Sikaflex®, SikaPower®, and SikaForce®.

(Meth)acrylate adhesives are two-component adhesives whose first components comprises acrylic acid and/or methacrylic acid and/or esters thereof and whose second component comprises a free-radical initiator, more particularly a peroxide. Preferred such adhesives are available commercially under the product lines SikaFast® from Sika Schweiz AG.

Epoxy resin adhesives are adhesives which are formulated on the basis of glycidyl ethers, more particularly of diglycidyl ether of bisphenol A and/or bisphenol F. Particularly suitable two-component epoxy resin adhesives are those whose one component comprises diglydicyl ethers of bisphenol A and/or bisphenol F and whose second component comprises polyamines and/or polymercaptans. Preference is given to two-component epoxy resin adhesives of the kind available commercially under the product line Sikadur® from Sika Schweiz AG. Having emerged as being particularly suitable for the adhesive bonding of films are the two-component epoxy resin adhesives Sikadur® Combiflex®, Sikadur® 31, Sikadur® 31DW, and Sikaduro 33, preferably Sikadur® Combiflex®, from Sika Schweiz AG.

Adhesives based on alkoxysilane-functional prepolymers are, more particularly, adhesives based on MS polymers or SPUR (silane-terminated polyurethanes) prepolymers. Alkoxysilane-functional prepolymers of this kind can be prepared, for example, by way of a hydrosilylation reaction from polyethers containing at least two C═C double bond, more particularly from allyl-terminated polyoxyalkylene polymers, and with a hydrosilane, or by way of an addition reaction of isocyanatoalkylalkoxysilanes with polyols or with hydroxyl-functional polyurethane prepolymers, or via an addition reaction of aminoalkylalkoxysilanes with isocyanate-functional polyurethane prepolymers, the polyurethane prepolymers themselves being accessible via a reaction of polyisocyanates and polyols and/or polyamines in a known way. Adhesives based on alkoxysilane-functional prepolymers are moisture-curing and react at room temperature.

In principle it is also possible to use reactive hot-melt adhesives, of the kind sold commercially by Sika Schweiz AG under the product line SikaMelt®. Preference, however, is given to room-temperature-curing adhesives.

If required, prior to the applying of the adhesive or sealant, the substrates may additionally be pretreated for the application of an adhesion promoter composition. Besides the application of an adhesion promoter, an adhesion promoter solution or a primer, pretreatments of this kind encompass, more particularly, physical and/or chemical cleaning methods, examples being abrading, sandblasting, brushing or the like, or treatment with cleaners or solvents.

The adhesive bonding or sealing of the substrates S1 and S2 in accordance with a method of the invention produces an adhesively bonded or sealed article. An article of this kind may be a built structure, more particularly a built structure of construction or civil engineering, or a means of transport. Preferably the article is a means of transport, such as a water or land vehicle, for example, more particularly an automobile, a bus, a truck, a train or a ship, or a component for installation thereon. With particular preference the adhesively bonded or sealed article is a means of transport, more particularly an automobile, or a component for installation on a means of transport, more particularly an automobile.

It will be appreciated that the invention is not confined to the exemplary embodiment described and shown. It will be understood that the aforementioned features of the invention can be used not only in the combination specifically indicated but also in other modifications, combinations, and amendments or on their own, without departing from the scope of the invention.

### Examples

### Preparation of the Adhesion Promoter Composition

For the spraying experiments with the ultrasonic atomizer the adhesion promoter composition from table 1 was used.

TABLE 1
Adhesion promoter composition

| Amount | | Name | Supplier |
|---|---|---|---|
| 1% | by weight | Silquest ® A1110 | GE Speciality |
| | | | Materials, |
| | | | Switzerland |
| 0.5% | by weight | Hydropalat ® 120 | Cognis, Germany |
| 1% | by weight | Acetic acid (100%) | Fluka, Switzerland |
| 97.5% | by weight | Water | |

### Experimental Setup

For supplying the adhesion promoter composition to an ultrasonic atomizer a peristaltic pump was used of the REGLO Digital type from Ismatec SA, Switzerland, with 12 tube rolls and a tube with an internal diameter of 1.09 mm. After the pump has been calibrated, it automatically calculates the rotational speed necessary for the preselected amount. The adhesion promoter composition was passed into an ultrasonic atomizer of type US2 from Lechler GmbH, with a constant supply rate of approximately 0.75 or 0.95 ml/min, and atomized at 58 kHz. The exit aperture of the ultrasonic atomizer was installed at a distance of 6.5 cm from the substrate. The substrate used was a glass ceramic test element from Rochol GmbH. The application speed selected was about 20 cm/s; in other words, the exit aperture of the ultrasonic atomizer moved at a speed of 20 cm/s relative to the glass ceramic surface. In order to generate a defined jet of mist, insensitive to extraneous air disturbance, a stream of carrier air of approximately 25 l/min was passed through the atomizer.

By means of this system it was possible to apply the adhesion promoter composition to the substrate with an application breadth of approximately 2.5 cm. After a flash-off time of approximately 15 seconds, a dry film thickness of the adhesion promoter composition was obtained of 0.08 to 0.14 μm. With this method of the invention it was possible to apply an adhesion promoter composition at a relatively constant film thickness to a confined area, thereby allowing the problem of what is called overspray to be minimized.

### Tests on the Adhesive Bond

Approximately 24 hours after the application of the adhesion promoter composition to a glass ceramic surface, the one-component, moisture-curing polyurethane adhesive Sikaflex® 250 DM-2 (“DM2”), which comprises polyurethane prepolymers with isocyanate groups and is available commercially from Sika Schweiz AG, was applied in the form of a flat triangular bead, using a cartridge press and a nozzle, and was cured for 5 days at 23° C. and 50% relative humidity (climatic storage “CL”).

The adhesion of the adhesive was tested by means of the ‘bead test’. In this test, the bead is incised at the end just above the adhesion face. The incised end of the bead is held with round-end tweezers and pulled from the substrate. This is done by carefully rolling up the bead on the tip of the tweezers, and placing a cut vertical to the bead pulling direction down to the bare substrate. The rate of bead removal is selected so that a cut has to be made around every 3 seconds. The test length must amount to at least 8 cm. An assessment is made of the adhesive which remains on the substrate after the bead has been pulled off (cohesive fracture). The adhesion properties are evaluated by estimation of the cohesive fraction of the adhesion face:

1=>95% cohesive fracture
2=75-95% cohesive fracture
3=25-75% cohesive fracture
4=<25% cohesive fracture
5=0% cohesive fracture (purely adhesive fracture)

Test results with cohesive fractures of less than 75%, i.e., those graded 3, 4, or 5, are considered inadequate.

The adhesion results from table 2 show that effective adhesion of the adhesive to the glass ceramic surface is obtained when the adhesion promoter composition has been applied in an amount of 0.95 ml/min and with a carrier air (CA) flow of around 25 l/min.

TABLE 2
Adhesion of adhesive DM-2 to aqueous adhesion
promoter composition after differing amounts
of adhesion promoter composition applied.

Application rate

| | |
|---|---|
| 0.75 ml/min | 0.95 ml/min |

| Carrier air (CA) | No CA | With CA | With CA |
|---|---|---|---|
| DM-2 | 3 | 3 | 2 |

Abbreviations:
CA = carrier air,
DM-2 = Sikaflex ® 250 DM-2

1. A method of applying a hydrolysable liquid comprising:
applying the hydrolyzable liquid to at least one substrate surface with an ultrasonic atomizer.

2. The method of claim 1, wherein the hydrolyzable liquid is an adhesion promoter composition.

3. The method of claim 2, wherein the adhesion promoter composition comprises at least one adhesion promoter substance selected from the group consisting of organosilicon compound, organotitanium compound, and organozirconium compound.

4. The method of claim 3, wherein the adhesion promoter composition further comprises at least one solvent.

5. The method of claim 1, wherein the ultrasonic atomizer is part of an applicator nozzle.

6. The method of claim 1, wherein the ultrasonic atomizer comprises at least one piezoelectric element.

7. The method of claim 1, wherein the ultrasonic atomizer generates droplets having a diameter with a maximum in a frequency distribution of less than 100 μm.

8. The method of claim 1, wherein the hydrolyzable liquid is applied to the substrate surface with the aid of at least one carrier gas.

9. The method of claim 8, wherein the carrier gas comprises an additional component, which is applied to the substrate surface with a droplet, generated by the ultrasonic atomizer, of a first component, which comprises at least one hydrolyzable liquid.

10. The method of claim 9, wherein the first component contains at least one functional group and the second component contains at least one functional group, and the functional group of the first component and the functional group of the second component react with one another chemically.

11. The method of claim 9, wherein the second component comprises a catalyst.

12. The method of claim 1, wherein the substrate is glass, metal or ceramic.

13. (canceled)

14. A method of adhesively bonding a first substrate and a second substrate comprising the steps of
applying an adhesion promoter composition in accordance with the method of claim 1 to the first substrate and/or to the second substrate;
applying an adhesive to the first substrate and/or the second substrate;
contacting the first and the second substrate with the applied adhesive; and
curing the adhesive,
the first substrate and the second substrate being alike or different from one another.

15. A method of sealing, comprising the steps of
applying an adhesion promoter composition in accordance with the method of claim 1 to a first substrate and/or a second substrate;
applying a sealant between the first substrate and the second substrate; and
curing the sealant,
the first substrate and the second substrate being alike or different from one another.

16. The method of claim 14, wherein at least one of the first substrate and the second substrate is glass, glass ceramic, concrete, mortar, brick, tile, plaster, a natural stone such as granite or marble; a metal or an alloy such as aluminum, steel, nonferrous metal, galvanized metal; a wood, a plastic such as PVC, polycarbonate, PMMA, polyester, epoxy resin; a powder coating, a paint or a finish.

17. An adhesively bonded article produced by the method of claim 14.

18. A sealed article produced by the method of claim 15.

19. An adhesively bonded article of claim 17, wherein the article is a built structure, an industrial product or a means of transport.
